(19) United States
(12) Patent Application Publication
(10) Pub. No.: US 2012/0099591 A1
(43) Pub. Date: Apr. 26, 2012

(54) System and Method for Scalable Flow Aware Network Architecture for Openflow Based Network Virtualization

(75) Inventors: Saikrishna Kotha, Austin, TX (US); Gaurav Chawla, Austin, TX (US)

(73) Assignee: DELL PRODUCTS, LP, Round Rock, TX (US)

(21) Appl. No.: 12/912,198

(22) Filed: Oct. 26, 2010

(51) Int. Cl. H04L 12/56; G06F 15/16

(52) U.S. Cl. 370/392; 709/234

(57) ABSTRACT

A network device includes a memory configured to store a flow table, and a processor. The processor is configured to receiving a network packet, determine the network packet corresponds to an unidentified network flow, and provide flow information for the unidentified network flow to a controller. The processor is further configured to receive a flow identifier and an flow table entry from the controller. The flow table entry includes a flow rule and an encapsulate instruction. The processor is further configured to store the flow rule in the flow table, encapsulate the network packet using the flow identifier, and forward the encapsulated network packet to the network.

### FIELD OF THE DISCLOSURE

This disclosure generally relates to information handling systems, and more particularly to scalable flow aware network architecture for OpenFlow based network virtualization.

### BACKGROUND

As the value and use of information continues to increase, individuals and businesses seek additional ways to process and store information. One option is an information handling system. An information handling system generally processes, compiles, stores, or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, data storage systems, and networking systems.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are illustrated and described with respect to the drawings presented herein, in which:

FIG. 1 is a functional block diagram of a routing architecture according to an embodiment of the present disclosure;

FIG. 2 is a functional block diagram of a network communications system according to an embodiment of the present disclosure;

FIG. 3 is a view of a data packet at various points of the network of FIG. 2;

FIG. 4 is a flow diagram illustrating a method for routing traffic through a network according to an embodiment of the present disclosure; and

FIG. 5 is a functional block diagram illustrating an information handling system according to one aspect of the disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can be used in this application. The teachings can also be used in other applications, and with several different types of architectures, such as distributed computing architectures, client/server architectures, or middleware server architectures and associated resources.

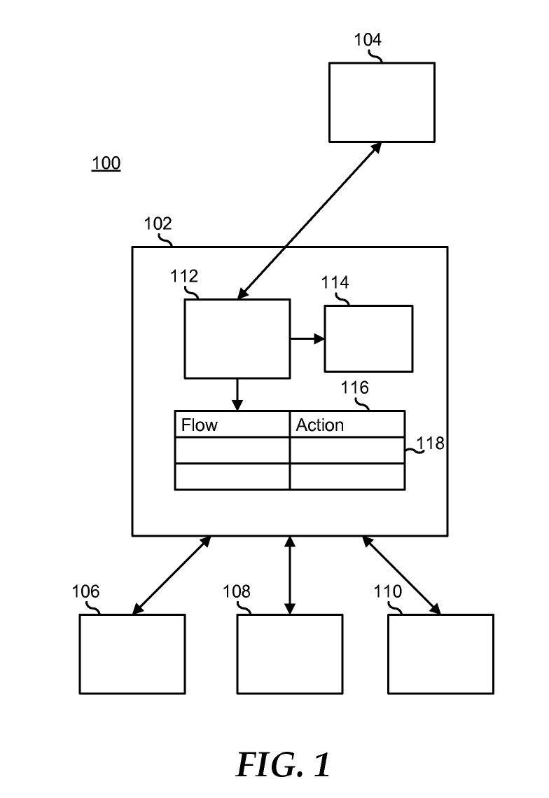

FIG. 1 illustrates an exemplary network architecture 100, such as an OpenFlow architecture, for use with an information handling system. For purposes of this disclosure, an information handling system can include any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a PDA, a consumer electronic device, a network server or storage device, a switch router, wireless router, or other network communication device, or any other suitable device and can vary in size, shape, performance, functionality, and price. The information handling system can include memory (volatile such as random-access memory), nonvolatile such as read-only memory or flash memory) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as various input and output (I/O) devices such as a keyboard, a mouse, a video/graphic display, or any combination thereof. The information handling system can also include one or more buses operable to transmit communications between the various hardware components. Portions of an information handling system may themselves be considered information handling systems.

Network architecture 100 includes a switch 102 and a controller 104. Switch 102 can direct network traffic between computer systems 106, 108, and 110. Controller 104 can provide routing rules for routing the traffic through switch 102. Controller 104 may provide routing rules to a plurality of switches within a network, enabling the network to route traffic based on criteria in addition to a source and destination address. For example, email traffic between two computer systems can be routed along one path while Voice over Internet Protocol (VoIP) traffic between the two computer systems can be routed along another path, such as a path with lower latency.

Switch 102 can include a secure channel 112 for communication with the controller 104. Switch 102 can also include a Forwarding Database (FDB) 114 and a flow table 116. In an embodiment, the flow table 116 can be implemented in a ternary content addressable memory (TCAM). The FDB 114 can store MAC address port pairings to indicate to which port traffic destined for a MAC address should be sent. The flow table 116 can have a flow table entry 118 including a flow rule and an action. Additionally, the flow table 116 may implement a counter to collect statistics on the amount of traffic within a flow. The flow rule can match portions of a header of a packet, such as a source address, a destination address, a type of packet, a communications protocol, a port on the switch, a virtual local area network identifier, and the like. The controller 104 can send instructions to the switch 102 through the secure channel 112 to manipulate entries in the FDB 114 or the flow table 116 to manage the flow of traffic through the switch.

In an example, when the switch 102 receives a network packet from computer system 106, the switch 102 can compare the network packet to the entries within the flow table 116. If the network packet matches flow table entry 118, the switch 102 can perform an action indicated by flow table entry 118. For example, the action can indicate to which port of switch 102 the network packet should be forwarded. Alternatively, the switch 102 can match the network packet to an entry in the FDB 114 based on the destination address, and send the network packet out the port indicated by the FDB 114.

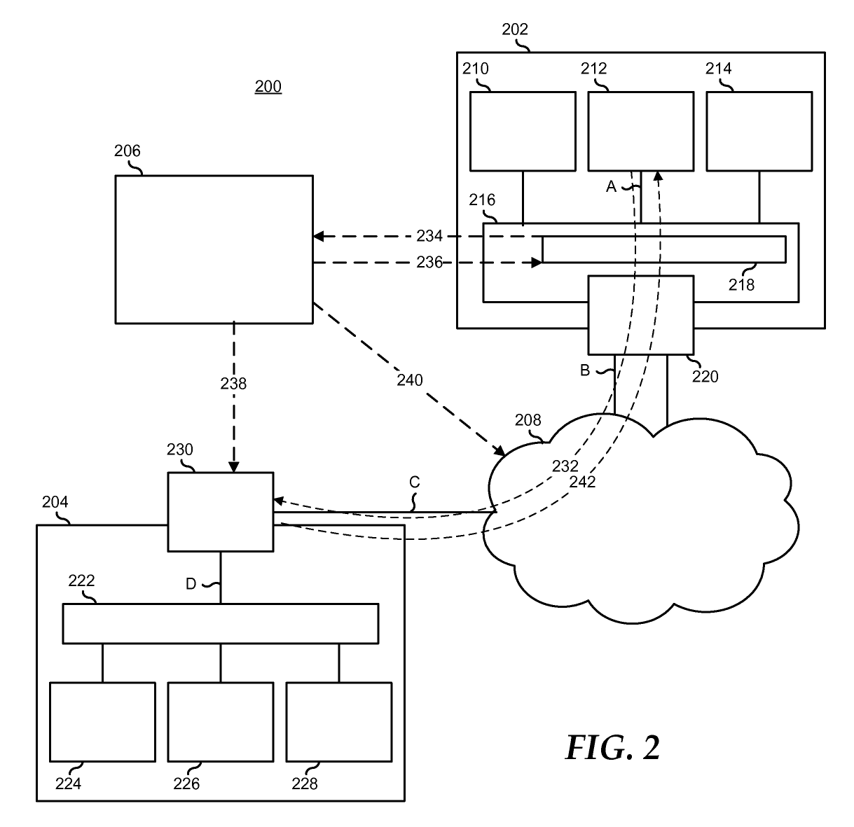

FIG. 2 illustrates an embodiment of a network communications system 200 including computer systems 202 and 204, and a controller 206. Computer systems 202 and 204 and controller 206 can communication through a network 208. Network 208 can include one or more switches, such as switch 102.

Computer system 202 can include virtual machines 210, 212, and 214 under the control of a hypervisor 216. Hypervisor 216 can implement a virtual switch 218 to route communication between virtual machines 210, 212, and 214 and the network 208. Additionally, computer system 202 can include a network interface card (NIC) 220 as a hardware interface between computer system 202 and the network 208.

Computer system 204 can include an operating system 222 and applications 224, 226, and 228 running under the control of operating system 222. Additionally, computer system 204 can include a NIC 230 as a hardware interface between computer system 204 and the network 208. In an embodiment, NIC 230 can be a converged network adapter and can be configured to operate under the control of controller 206.

In an embodiment, virtual machine 212 can send a network packet A destined for application 226 on computer system 204, as indicated by arrow 232. Upon receiving network packet A, virtual switch 218 can detect a new flow. Virtual switch 218 can notify controller 206 and provide information about the new flow to controller 206, as indicated by arrow 234. The controller 206 may generate a flow rule and assign a flow identifier for the new flow. The flow identifier can be a controller-assigned media access control (MAC) address, a controller-assigned IP address, or another identifier used to route traffic through network 208. The flow rule and flow identifier may be added to a flow table of the controller, as illustrated in Table 1.

TABLE 1
Flow Table Entry of Controller 206

| Flow rule tuple | Flow Identifier | Node Info |
|---|---|---|
| Flow-1 | Controller-assigned MAC1 | Computer System 202 |

The controller 206 can provide the flow identifier and appropriate flow rules to virtual switch 218 and network interface card 230, as indicated by arrows 236 and 238. The flow rule for virtual switch 218 can indicate that the network packet should be encapsulated with the flow identifier, and the flow rule for NIC 230 can indicate that the network packet should be decapsulated. Additionally, the controller can instruct network interface card 230 to respond to the flow identifier. Virtual switch 218 and NIC 230 can add the flow rules provided by the controller to their respective flow tables, as illustrated by Tables 2 and 3.

TABLE 2
Flow Table Entry for Virtual Switch 218

| Flow rule tuple | Flow Identifier | Node Info |
|---|---|---|
| Flow-1 | Controller-assigned MAC1 | Encapsulate |

TABLE 3
Flow Table Entry for NIC 230

| Flow rule tuple | Flow Identifier | Node Info |
|---|---|---|
| Flow-1 | Controller-assigned MAC1 | Decapsulate |

Virtual switch 218 can encapsulate the network packet, such as by adding a header including the flow identifier, and can forward an encapsulate network packet B to network 208. NIC 230 can receive the encapsulated network packet, now designated encapsulated network packet C. NIC 230 can match the encapsulated network packet C to the appropriate flow table rule and decapsulate the encapsulated network packet C, such as by removing the heading including the flow identifier, to obtain the network packet D. The NIC 230 can provide the network packet D or a payload of the network packet D to the operating system 222 for passage to application 226.

Return traffic, as indicated by arrow 242, can undergo similar processing, with NIC 230 detecting a new flow and controller 206 assigning another flow identifier to the flow from application 226 to virtual machine 212. NIC 230 can encapsulate the network packets with the flow identifier, and virtual switch 218 can decapsulate the encapsulated network packets prior to passing the network packets to virtual machine 212.

In another embodiment, NIC 230 may be unable to decapsulate the encapsulated network packets. Controller 206 can instruct an edge switch within network 208 and adjacent to computer system 204 to decapsulate the encapsulated network packets prior to forwarding the network packets to NIC 230. Additionally, NIC 230 may be unable to detect new flows and controller 206 can instruct the edge switch to detect new traffic flows from computer system 204 and to encapsulate the network packets.

In an embodiment, controller 206 can provide the flow identifier and a path for the traffic flow to switches within network 208, as indicated by arrow 240. The switches can be configured to direct the encapsulated network packets along a path selected by the controller. For example, the controller 206 can provide an FDB entry for the controller-assigned MAC address to the switches along the path, as illustrated in Table 4. Alternatively, at least a portion of the switches within network 208 may be unable to be configured by controller 206 and can direct the encapsulated network packets along a patch determined by traditional network discovery protocols.

TABLE 4
FDB Entry for Switches Along Path

| MAC address | Destination Port |
|---|---|
| Controller-assigned MAC1 | PortX |

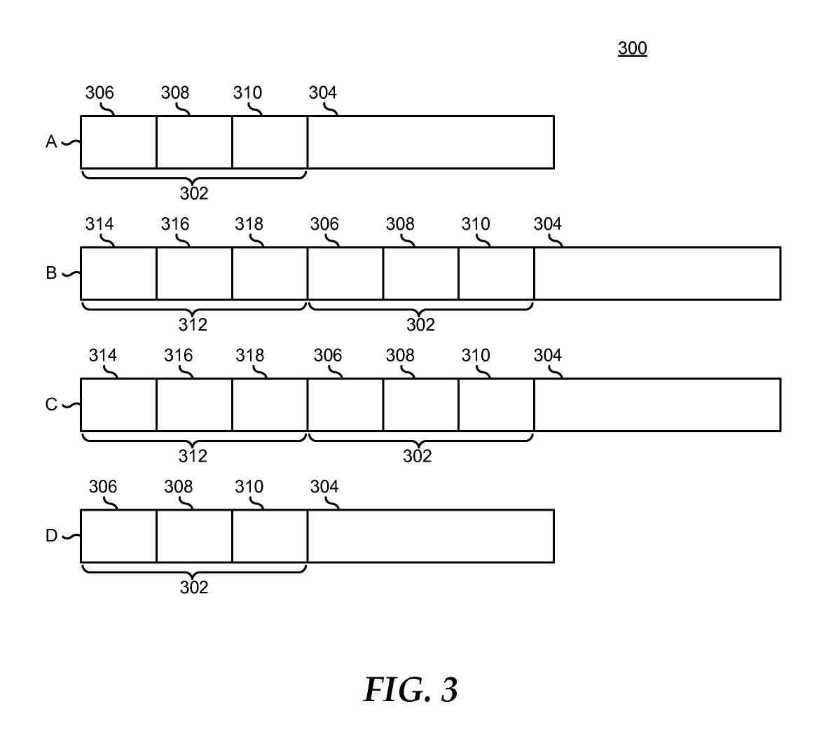

FIG. 3 illustrates embodiments of a network packet, generally designated 300, at various locations through network communications system 200. Network packet A, as sent from virtual machine 212 to virtual switch 218 can include a header 302 and a payload 304. The header 302 can include a destination MAC address 306, a source MAC address 308, and an EtherType/Length field 310. The destination MAC address 306 can corresponding to the MAC address of NIC 230, and the source MAC address 308 can correspond to the MAC address of virtual machine 212.

After encapsulation by virtual machine 212, network packet B, as sent from NIC 220 to network 208, can include a encapsulation header 312, header 302, and payload 304. Encapsulation header 312 can include a destination MAC address 314, a source MAC address 316, and an EtherType field 318. The destination MAC address 314 can correspond to the flow identifier assigned by controller 206, and the source MAC address 316 can correspond to the MAC address of virtual machine 212.

After passage through network 208, network packet C, as received by NIC 230, can be substantially similar to network packet B. Network packet C can include encapsulation header 312, header 302, and payload 304. Encapsulation header 312 can include a destination MAC address 314, a source MAC address 316, and an EtherType field 318. The destination MAC address 314 can correspond to the flow identifier assigned by controller 206, and the source MAC address 316 can correspond to the MAC address of virtual machine 212.

After decapsulation by NIC 230, network packet D can be substantially similar to network packet A. Network packet A can include a header 302 and a payload 304. The header 302 can include a destination MAC address 306, a source MAC address 308, and an EtherType/Length field 310. The destination MAC address 306 can corresponding to the MAC address of NIC 230, and the source MAC address 308 can correspond to the MAC address of virtual machine 212.

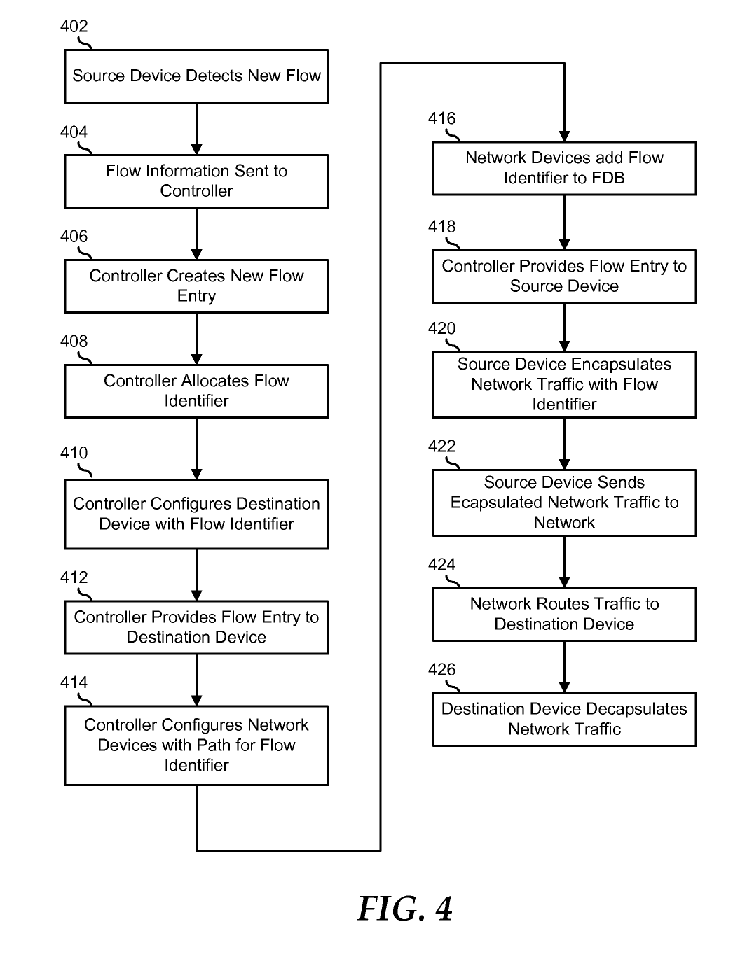

FIG. 4 illustrates a method for routing network traffic through a network communications system, such as network communications system 200. At 402, a source device can detect a new flow. The source device can be a virtual switch, such as virtual switch 218, a NIC, such as NIC 230, or a switch, such as switch 102. Detection of the new flow can be based upon predefined flow identification rules. For example, a new flow can be identified when a network packet does not match any existing flow rules. The existing flow rules can include flow rules for specific flows, or generic flow rules for classes of flows. An example of a specific flow rule can match a VoIP stream from a first network device to a second network device. An example of a generic flow rule can match all incoming email traffic flows to a POP server on port 110.

At 404, the source device can send flow information about the new flow to a controller, such as controller 206. In an embodiment, the source device can send an exemplary packet to the controller. Alternatively, the source device can extract information from the header and forward the header information to the source device. At 406, the controller can create a new flow entry based on the flow information provided by the source device, and at 410, the controller can allocate a flow identifier for the new flow. The flow identifier can be a controller-assigned MAC address, a controller-assigned IP address, or the like.

At 410, the controller can send an instruction to a destination device. The destination device can be a virtual switch, such as virtual switch 218, a NIC, such as NIC 230, or a switch, such as switch 102. The instruction can direct the destination device to respond to the flow identifier. For example, when the flow identifier is a controller-assigned MAC address, the instruction can direct the destination device to respond to network packets addressed to the controller-assigned MAC address in addition to any MAC addresses the destination device is currently responding to. The controller can also provide a flow entry to the destination device, as illustrated at 412. The flow entry can indicate that the destination device should decapsulate packets matching the flow identifier. For example, network packets having the controller-assigned MAC address as a destination address can be decapsulated.

At 414, the controller can configure network devices, such as switch 102, with a path for flow, and at 416, the network devices can add the flow identifier to the FDB. For example, the controller can send a FDB entry to each switch along the path that is configurable by the controller. The FDB entry can indicate which port the network packets matching the controller-assigned MAC address should be sent along. Significantly, as switches typically can store a significantly larger number of entries in the FDB than in the flow table, matching the network packets to the flow based on a controller-assigned MAC address can be more scalable than utilizing a flow table entry for each network flow. If the network contains switches that are not configurable by the controller, these switches can discover the path for the flow identifier by communicating with other network devices using standard network discovery protocols.

At 418, the controller can provide a flow entry to the source device. The flow entry can indication which network packets correspond to the flow and can instruct the source device to encapsulate the network packets with the flow identifier. For example, the flow entry can instruct the source device to encapsulate the network packets corresponding to the flow with a header indicating the controller-assigned MAC address as a destination address. The source device can encapsulate the network packets matching the flow, as indicated at 420, and can send the encapsulated network packets to the network, as indicated at 422.

At 424, the network devices can forward the encapsulated packets through the network until they reach the destination network device. At 426, the destination network device can decapsulate the encapsulated network packets matching the flow identifier. For example, when the destination MAC address matches the controller-assigned MAC address, the destination network device can remove the encapsulation header and provide the network packet to the intended computer system.

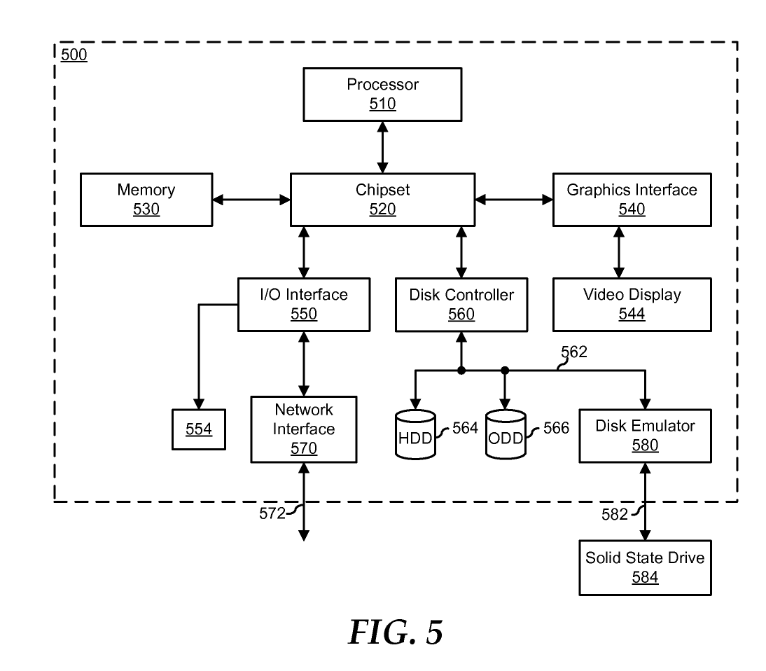

In a particular embodiment, an information handling system can be used to function as one or more of the network systems, or carry out one or more of the methods described above. In another embodiment, one or more of the systems described above can be implemented in the form of an information handling system. FIG. 5 illustrates a functional block diagram of an embodiment of an information handling system, generally designated as 500. Information handling system 500 includes processor 510, a chipset 520, a memory 530, a graphics interface 540, an input/output (I/O) interface 550, a disk controller 560, a network interface 570, and a disk emulator 580.

Processor 510 is coupled to chipset 520. Chipset 520 supports processor 510, allowing processor 510 to process machine-executable code. In a particular embodiment, information handling system 500 includes one or more additional processors, and chipset 520 supports the multiple processors, allowing for simultaneous processing by each of the processors, permitting the exchange of information between the processors and the other elements of information handling system 500. Processor 510 can be coupled to chipset 520 via a unique channel, or via a bus that shares information between processor 510, chipset 520, and other elements of information handling system 500.

Memory 530 is coupled to chipset 520. Memory 530 can be coupled to chipset 520 via a unique channel, or via a bus that shares information between chipset 520, memory 530, and other elements of information handling system 500. In particular, a bus can share information between processor 510, chipset 520 and memory 530. In a particular embodiment, processor 510 is coupled to memory 530 through a unique channel. In accordance with another aspect, an information handling system can include a separate memory dedicated to each of the processors. A non-limiting example of memory 530 includes static, dynamic, or non-volatile random access memory (SRAM, DRAM, or NVRAM), read only memory (ROM), flash memory, another type of memory, or any combination thereof.

Graphics interface 540 is coupled to chipset 520. Graphics interface 540 can be coupled to chipset 520 via a unique channel, or via a bus that shares information between chipset 520, graphics interface 540, and other elements of information handling system 500. Graphics interface 540 is coupled to a video display 544. Other graphics interfaces can also be used in addition to graphics interface 540 if needed or desired. Video display 544 can include one or more types of video displays, such as a flat panel display or other type of display device.

I/O interface 550 is coupled to chipset 520. I/O interface 550 can be coupled to chipset 520 via a unique channel, or via a bus that shares information between chipset 520, I/O interface 550, and other elements of information handling system 500. Other I/O interfaces can also be used in addition to I/O interface 550 if needed or desired. I/O interface 550 is coupled to one or more add-on resources 554. Add-on resource 554 can also include another data storage system, a graphics interface, a network interface card (NIC), a sound/video processing card, another suitable add-on resource or any combination thereof.

Network interface device 570 is coupled to I/O interface 550. Network interface 570 can be coupled to I/O interface 550 via a unique channel, or via a bus that shares information between I/O interface 550, network interface 570, and other elements of information handling system 500. Other network interfaces can also be used in addition to network interface 570 if needed or desired. Network interface 570 can be a NIC disposed within information handling system 500, on a main circuit board (such as a baseboard, a motherboard, or any combination thereof), integrated onto another component such as chipset 520, in another suitable location, or any combination thereof. Network interface 570 includes a network channel 572 that provide interfaces between information handling system 500 and other devices that are external to information handling system 500. Network interface 570 can also include additional network channels.

Disk controller 560 is coupled to chipset 510. Disk controller 560 can be coupled to chipset 520 via a unique channel, or via a bus that shares information between chipset 520, disk controller 560, and other elements of information handling system 500. Other disk controllers can also be used in addition to disk controller 560 if needed or desired. Disk controller 560 can include a disk interface 562. Disk controller 560 can be coupled to one or more disk drives via disk interface 562. Such disk drives include a hard disk drive (HDD) 564 or an optical disk drive (ODD) 566 (such as a Read/Write Compact Disk (R/W-CD), a Read/Write Digital Video Disk (R/W-DVD), a Read/Write mini Digital Video Disk (R/W mini-DVD), or another type of optical disk drive), or any combination thereof. Additionally, disk controller 560 can be coupled to disk emulator 580. Disk emulator 580 can permit a solid-state drive 584 to be coupled to information handling system 500 via an external interface. The external interface can include industry standard busses (such as USB or IEEE 1384 (Firewire)) or proprietary busses, or any combination thereof. Alternatively, solid-state drive 584 can be disposed within information handling system 500.

In a particular embodiment, HDD 544, ODD 566, solid state drive 584, or a combination thereof include a computer-readable medium in which one or more sets of machine-executable instructions such as software, can be embedded. For example, the instructions can embody one or more of the methods or logic as described herein. In a particular embodiment, the instructions reside completely, or at least partially, within memory 530, and/or within processor 510 during execution by information handling system 500. Memory 530 and processor 510 can also include computer-readable media.

When referred to as a “device,” a “module,” or the like, the embodiments described above can be configured as hardware, software (which can include firmware), or any combination thereof. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). Similarly, the device could be software, including firmware embedded at a device, such as a Pentium class or PowerPC™ brand processor, or other such device, or software capable of operating a relevant environment of the information handling system. The device could also be a combination of any of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A network device comprising:
a memory configured to store a flow table; and
a processor configured to:
receive a network packet;
determine that the network packet corresponds to an unidentified network flow;
provide flow information for the unidentified network flow to a controller;
receive, from the controller, a flow identifier and a flow table entry, the flow table entry including a flow rule and an encapsulate instruction;
store the flow rule in the flow table;
encapsulate the network packet using the flow identifier; and
forward the encapsulated network packet to the network.

2. The network device of claim 1, wherein the flow identifier includes a controller-assigned media access control address, a controller-assigned Internet Protocol address, or any combination thereof.

3. The network device of claim 2, wherein the flow identifier includes the controller-assigned media access control address, and the processor is configured to encapsulate the network packet by adding a header including the controller-assigned media access control address to the network packet.

4. The network device of claim 1, wherein the processor is further configured to:
receive, from the controller, a second flow identifier and a second flow table entry, the second flow table entry including a second flow rule and a decapsulate instruction;
store the second flow rule in the flow table;
receive a second network packet matching the flow rule; and
decapsulate the second network packet.

5. The network device of claim 4, wherein the second flow identifier includes a second controller-assigned media access control address, and the processor is configured to decapsulate the second network packet by removing a header including the second controller-assigned media access control address from the second network packet.

6. The network device of claim 1, wherein the flow information includes the network packet, header information of the network packet, or any combination thereof.

7. A machine-executable method comprising:
receiving flow information corresponding to an unidentified network flow from a source network device;
creating a flow entry for the unidentified network flow, the flow entry corresponding to at least a portion of the flow information;
allocating a flow identifier for the unidentified network flow;
providing the flow identifier and a flow table entry to the source network device, the flow table entry including a flow rule and an encapsulate instruction; and
providing the flow identifier and a second flow table entry to a destination network device, the second flow table entry including a flow rule and a decapsulate instruction.

8. The method of claim 7, further comprising sending routing instructions corresponding to the flow identifier to a plurality of network switches.

9. The method of claim 7, wherein the flow identifier includes a controller-assigned media access control address, a controller-assigned Internet Protocol address, or any combination thereof.

10. The method of claim 7, wherein the flow information includes a network packet, header information of the network packet, or any combination thereof.

11. The method of claim 7, wherein the source network device includes a virtual switch, a converged network adapter, a edge router, or any combination thereof.

12. The method of claim 7, wherein the destination network device includes a virtual switch, a converged network adapter, a edge router, or any combination thereof.

13. Machine-executable code for an information handling system, wherein the machine-executable code is embedded within a non-transitory medium and includes instructions for carrying out a method, the method comprising:
receiving a network packet;
determining that the network packet corresponds to an unidentified network flow;
providing flow information for the unidentified network flow to a controller;
receiving, from the controller, a controller-assigned media access control address and a flow table entry, the flow table entry including a flow rule and an encapsulate instruction;
storing the flow rule in the flow table;
encapsulating the network packet to include the controller-assigned media access control address; and
forwarding the encapsulated network packet to the network.

14. The machine-executable code of claim 13, wherein encapsulating the network packet includes adding a header including the controller-assigned media access control address to the network packet.

15. The machine-executable code of claim 13, wherein the method further comprising:
receiving, from the controller, a second controller-assigned media access control address and a second flow table entry, the second flow table entry including a second flow rule and a decapsulate instruction;
storing the second flow rule in the flow table;
receiving a second network packet including the second controller-assigned media access control address and matching the second flow rule; and
decapsulating the second network packet.

16. The machine-executable code of claim 15, wherein decapsulating the second network packet includes removing a header including the second controller-assigned media access control address from the second network packet.

17. The machine-executable code of claim 13, wherein the flow information includes the network packet, header information of the network packet, or any combination thereof.
